(19) United States
(12) Patent Application Publication
(10) Pub. No.: US 2010/0042481 A1
(43) Pub. Date: Feb. 18, 2010

(54) METHOD AND SYSTEM FOR EVALUATING QUALITY INSPECTION

(75) Inventors: Sining Wei, Shenzhen (CN); Naifeng Zhuang, Shenzhen (CN); Wei Huang, Shenzhen (CN); Zhiyong Wu, Shenzhen (CN); Chunan Jian, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: HUAWEI TECHNOLOGIES CO., LTD., Shenzhen (CN)

(21) Appl. No.: 12/603,079

(22) Filed: Oct. 21, 2009

Related U.S. Application Data
(63) Continuation of application No. PCT/CN2008/071020, filed on May 20, 2008.

(30) Foreign Application Priority Data
Sep. 13, 2007 (CN) 200710153001.X

(51) Int. Cl. G06Q 10/00

(52) U.S. Cl. 705/11

(57) ABSTRACT

A method for evaluating quality inspection and system are provided. The method includes: determining an evaluation task and candidate service representatives of an evaluation process, and automatically fetching a service representative from the candidate service representatives; automatically acquiring service record data of the fetched service representative; and determining and storing a result of the evaluation process according to the obtained service record data. The system includes a task distributor (Auto Task Distribute), an automatic fetching device (AutoFetch), and an evaluation executor. Thus, a comprehensive, accurate, objective, fair, and just evaluation result is ensured.

### CROSS-REFERENCE TO RELATED APPLICATIONS

This application is a continuation of International Patent Application No. PCT/CN2008/071020, filed on May 20, 2008, which claims priority to Chinese Patent Application No. 200710153001.X, filed on Sep. 13, 2007, both of which are incorporated by reference herein in their entireties.

### FIELD OF THE TECHNOLOGY

The present invention relates to the field of communication technology, and more particularly to a method and system for evaluating quality inspection for a call center.

### BACKGROUND

A call center generally supports daily operation of a user service center through cooperation of a plurality of systems, such as an agent system, a workflow system, a knowledge base system, and an outbound call system. Each system has its own staff, which is collectively referred to as service representatives. In order to evaluate and appraise the performance of the service representatives, a quality inspection evaluation function needs to be provided.

In a common method for quality inspection evaluation, an examiner performs comprehensive scoring/evaluation on service quality of a service representative through real-time monitoring and playback of a service process track of the service representative and according to predefined specifications and criteria, and then summarizes a final evaluation result.

Currently, a quality inspection evaluation process includes the following blocks.

Block 1: Evaluation specifications and criteria, mainly evaluation specifications and scoring criteria, are defined for different evaluation objects.

Block 2: An evaluation plan is set, and evaluation objects to be evaluated (including a service representative to be evaluated and evaluation items), an examiner that performs the evaluation, and planned evaluation times and the like, are listed.

Here, the evaluation items refer to specific contents to be evaluated, such as courtesy words.

Block 3: The examiner performs an evaluation task.

The examiner determines an evaluation task and a service representative of the evaluation task according to the set evaluation major plan that has not been completed, and obtains service record data of the service representative. A mode for obtaining the service record data may be as follows: when a real-time evaluation is performed, the service representative is monitored in real-time by a connection system; and when a post evaluation is performed, a service record of the service representative is selected from a service subsystem (for example, a database) for service track playback. Then, each evaluation item is evaluated according to the predefined specifications and criteria as well as the obtained service record data, and the system automatically summarizes scores of all evaluation items to obtain a final evaluation result.

In the implementation of the present invention, the inventor(s) found that the prior art at least has the following problems. As the examiner is required to obtain the evaluation plan through manual query, the quality inspection evaluation has a low efficiency. Meanwhile, the examiner is also required to manually fetch a service representative to be evaluated online, and manually query service record data of the service representative to be evaluated. As the manual fetching and manual query is easily affected by the intention of the examiner, it cannot be ensured that all service representatives are evaluated at the same probability, and it also cannot be ensured that each evaluation item of all service representatives is evaluated at the same probability. Therefore, the evaluation is not comprehensive and the evaluation result is not accurate, resulting in an unfair and unjust quality inspection evaluation.

For example, if the examiner has a bias against or a personal friendship with a service representative to be evaluated, evaluation times that the service representative is evaluated will inevitably be significantly more or significantly fewer than other service representatives; in another aspect, if the examiner knows an evaluation item where a service representative to be evaluated often makes a mistake and deliberately selects the evaluation item while ignoring other items, the evaluation will not be comprehensive enough and the evaluation result will not be accurate; in another aspect, the examiner will intentionally avoid evaluation items requiring complex evaluation processes (for example, service record data with difficult problems) or service representatives to be evaluated that are difficult to deal with by selecting other evaluation items or service representatives. Thus, the quality inspection evaluation result will not be comprehensive or accurate, resulting in an unfair and unjust quality inspection evaluation.

In addition, as the examiner is required to score the service representative according to the service record data and evaluation criteria during the evaluation, different examiners may give different evaluation results; for example, different examiners may give different scores for the same problem of the same severity, resulting in an inaccurate evaluation result.

### SUMMARY

Accordingly, the present invention is directed to a method and system for evaluating quality inspection, which avoid an evaluation difference caused by different examiners.

In order to achieve the above objective, in an embodiment, the present invention provides a method for evaluating quality inspection. The method is as follows.

An evaluation task and candidate service representatives of an evaluation process are determined by a quality inspection evaluation system, and a service representative of the evaluation process is automatically fetched from the candidate service representatives.

Service record data of the fetched service representative is automatically obtained by the quality inspection evaluation system according to the evaluation task.

A result of the evaluation process is determined by the quality inspection evaluation system according to the obtained service record data.

In an embodiment, the present invention further provides a quality inspection evaluation system. The system includes a task distributor, an automatic fetching device, and an evaluation executor.

The task distributor is adapted to determine an evaluation task of an evaluation process.

The automatic fetching device is adapted to automatically fetch a service representative of the evaluation process and automatically obtain service record data of the fetched service representative according to the evaluation task determined by the task distributor, and provide the service representative and the service record data to the evaluation executor.

The evaluation executor is adapted to play back the service record data obtained by the automatic fetching device, and determine a result of the evaluation process according to the service record data.

As can be seen from the above technical solutions, in the present invention, the quality inspection evaluation system firstly determines an evaluation task and candidate service representatives of an evaluation process, automatically fetches a service representative to be evaluated from the candidate service representatives, and then automatically obtains service record data of the service representative for evaluation according to the evaluation task, and finally determines and stores a result of the evaluation process according to the obtained service record data. As the quality inspection evaluation system automatically fetches the service representative to be evaluated and automatically obtains the service record data of the service representative when performing the determined evaluation task, the processes of fetching the service representative and obtaining the service record data will not be affected by human factors, ensuring that all service representatives are evaluated at the same probability, and each evaluation item of all the evaluated service representatives is evaluated at the same probability. Therefore, an evaluation difference caused by different examiners is avoided, thus obtaining a comprehensive, accurate, objective, fair, and just evaluation result.

### BRIEF DESCRIPTION OF THE DRAWINGS

The present invention will become more fully understood from the detailed description given herein below for illustration only, and thus are not limitative of the present invention, and wherein:

FIG. 1 is an overall flow chart of a method for evaluating quality inspection according to an embodiment of the present invention;

FIG. 2 is an overall structural view of a quality inspection evaluation system according to an embodiment of the present invention;

FIG. 3 is a detailed structural view of a quality inspection evaluation system according to Embodiment 1 of the present invention;

FIG. 4 is a detailed flow chart of a method for evaluating quality inspection according to Embodiment 1 of the present invention;

FIG. 5 shows a database relation between evaluation criteria, evaluation items, evaluation grades of the evaluation items, evaluation major plans, and plan details according to Embodiment 1 of the present invention;

FIG. 6 shows a relation between evaluation major plans, automatic fetching strategies, and rule conditions associated with the strategies according to Embodiment 1 of the present invention; and

FIG. 7 is a schematic view of an evaluation interface according to Embodiment 1 of the present invention.

### DETAILED DESCRIPTION

In order to the make the objectives, technical solutions, and advantages of the present invention comprehensible, embodiments of the present invention are described in detail below with reference to the accompanying drawings.

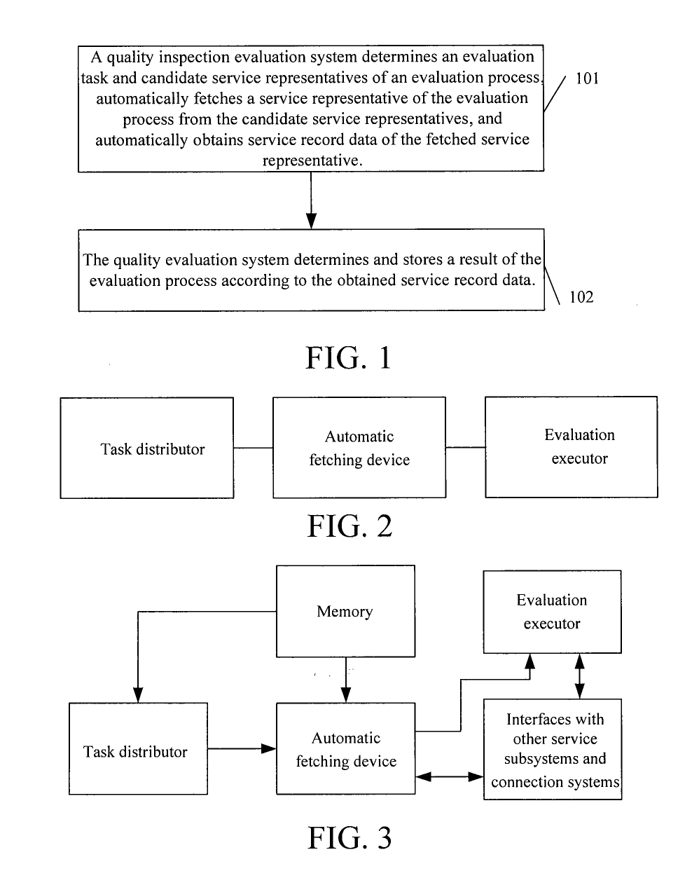

FIG. 1 is an overall flow chart of a method for evaluating quality inspection according to an embodiment of the present invention. Referring to FIG. 1, the method includes the following blocks.

Block 101: A quality inspection evaluation system determines an evaluation task and candidate service representatives of an evaluation process, automatically fetches a service representative of the evaluation process from the candidate service representatives, and automatically obtains service record data of the fetched service representative according to the evaluation task.

In this block, the evaluation task and the candidate service representatives of the evaluation process may be determined according to preset evaluation plans, or determined according to an evaluation authority of an examiner to service representatives if no evaluation plan is set. Specifically, if evaluation plans are preset, the quality inspection evaluation system may determine the evaluation task of the evaluation process according to an uncompleted evaluation plan, and determine the candidate service representatives according to the uncompleted evaluation plan. If no evaluation plan exists, the quality inspection evaluation system may preset an evaluation authority of an examiner to service representatives, and store times that each service representative is actually evaluated, which is referred to as actual evaluation times herein. When determining the candidate service representatives, the quality inspection evaluation system may select service representatives conforming to the evaluation authority from service representatives with actual evaluation times fewer than a preset threshold as candidate service representatives according to an identity (ID) of the examiner that performs the evaluation process.

The quality inspection evaluation system may automatically fetch the service representative and automatically obtain the service record data as follows: randomly fetching a service representative to be evaluated from the candidate service representatives, and randomly selecting service record data of the service representative corresponding to the evaluation task; alternatively, presetting an evaluation object fetching strategy, and fetching a service representative and obtaining service record data of the service representative according to the strategy. In addition, the mode for automatically fetching a service representative varies with different types of the evaluation task, and the details will be described in the following specific implementation.

Block 102: The quality inspection evaluation system determines and stores a result of the evaluation process according to the obtained service record data.

Thus, a quality inspection evaluation process according to the method for evaluating quality inspection of the present invention is completed.

The present invention further provides an embodiment of quality inspection evaluation system, which is applicable to the implementation of the method shown in FIG. 1. FIG. 2 is an overall structural view of the quality inspection evaluation system. Referring to FIG. 2, the system includes a task distributor (Auto Task Distribute), an automatic fetching device (AutoFetch), and an evaluation executor.

In the system, the task distributor is adapted to determine an evaluation task of an evaluation process. The automatic fetching device is adapted to automatically fetch a service representative of the evaluation process and automatically obtain service record data of the fetched service representative according to the evaluation task determined by the task distributor, and provide the service representative and the service record data to the evaluation executor. The evaluation executor is adapted to play back the service record data obtained by the automatic fetching device, and determine and store a result of the evaluation process according to the service record data.

As can be seen from the above description, in the present invention, when the evaluation task is performed, the processes of fetching the service representative and obtaining the service record data of the service representative are both automatically completed by the quality inspection evaluation system, and thus will not be affected by human factors, so that a comprehensive, accurate, objective, fair, and just quality inspection evaluation is ensured.

The above is a general description of the present invention, and the detailed description of the present invention is illustrated below through specific embodiments.

As described above, the processes of automatically fetching the service representative and automatically obtaining the service record data may be performed randomly or according to a preset strategy. When the automatic fetching and obtaining processes are performed according to the preset strategy, a specific implementation of the present invention is illustrated below through Embodiment 1.

### Embodiment 1

FIG. 3 is a detailed structural view of a quality inspection evaluation system according to Embodiment 1 of the present invention. The system structure is a specific implementation of the quality inspection evaluation system shown in FIG. 2. Referring to FIG. 3, the system specifically includes a task distributor, an automatic fetching device, an evaluation executor, a memory, and interfaces with other service subsystems and connection systems.

In the system, the memory is adapted to store preset evaluation major plans, plan details, evaluation criteria, evaluation items, and an automatic fetching strategy corresponding to each evaluation plan.

The task distributor is adapted to determine an evaluation task of an evaluation process, obtain current uncompleted evaluation major plans from the memory, and determine an evaluation major plan of the evaluation process according to a selection of an examiner.

The automatic fetching device is adapted to automatically fetch a service representative of the evaluation process and automatically obtain service record data of the fetched service representative according to the evaluation task determined by the task distributor, and provide the service representative and the service record data to the evaluation executor.

The evaluation executor is adapted to construct an evaluation interface according to the evaluation criteria and the evaluation items in the memory, play back the service record data corresponding to the service representative according to the selection of the examiner when performing a post evaluation, and determine and store a result of the evaluation process according to the service record data.

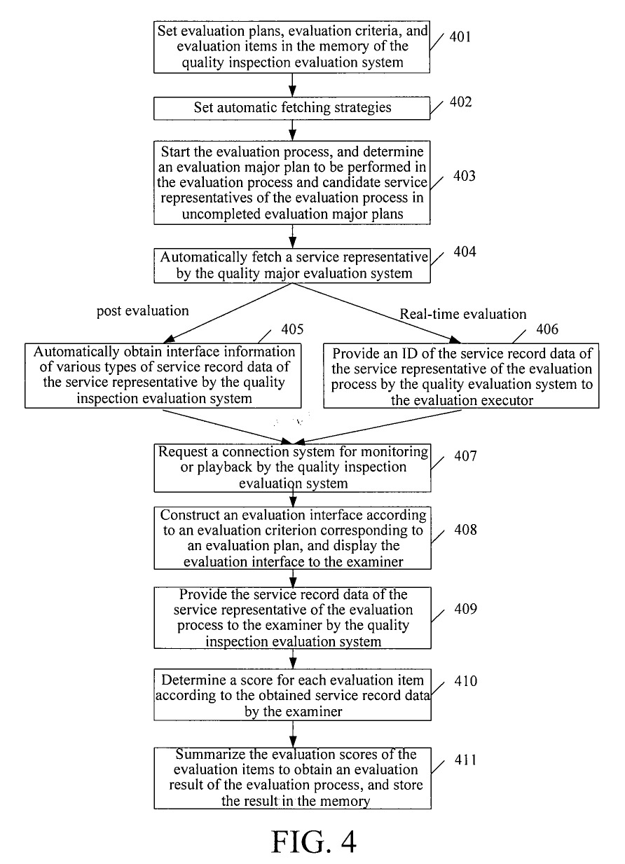

A specific method for evaluating quality inspection according to this embodiment is described in detail with reference to the quality inspection evaluation system shown in FIG. 3. FIG. 4 is a detailed flow chart of the method for evaluating quality inspection according to this embodiment. Referring to FIG. 4, the method includes the following blocks.

Block 401: Evaluation plans, evaluation criteria, and evaluation items are set in the memory of the quality inspection evaluation system.

In this block, before the quality inspection evaluation is performed, an evaluation plan may be set, i.e., a plan of evaluating a specific evaluation object is set and an examiner is designated to perform evaluation. The evaluation plan may be set according to an existing mode. For example, an evaluation plan is divided into a major plan and a plan detail. The major plan is a general description of the evaluation plan, and the plan detail is a detailed description of the evaluation plan in terms of evaluation objects and examiners. Specifically, the major plan may contain the following elements: a major plan ID, a major plan description, start time, end time, an evaluation criterion ID, and planned evaluation times. The plan detail may include an evaluation object plan detail and an examiner plan detail. The evaluation object plan detail may contain the following elements: a major plan ID (representing the evaluation object plan detail corresponding to the major plan), a service representative ID, planned evaluation times, and actual evaluation times (considering that a service representative to be evaluated may need to be evaluated for multiple times). The actual evaluation times are a record of times that the quality inspection evaluation system has evaluated the service representative. The examiner plan detail contains the following elements: a major plan ID (representing the examiner plan detail corresponding to a major plan) and an examiner ID. Any major plan has a corresponding evaluation object plan detail and a corresponding examiner plan detail, and a major plan may be corresponding to a plurality of evaluation object plan details so as to record information of a plurality of evaluation objects that needs to be evaluated in order to complete the major plan.

For different evaluation major plans, evaluation criteria and evaluation items contained therein are set. The evaluation criteria and evaluation items may be set according to an existing mode. For example, an evaluation criterion may contain the following elements: an evaluation criterion ID and an evaluation criterion description. An evaluation item may support a tree-like hierarchical structure, and contain the following elements: an evaluation item ID, a parent evaluation item ID (that is, an evaluation item ID of a parent node of the evaluation item in the tree-like hierarchical structure), an evaluation item description, a minimum score, a maximum score, and a default score.

In addition, in this embodiment, in order to avoid an evaluation difference between different examiners, evaluation grades of the evaluation items may further be set when the evaluation items are set. An evaluation grade may contain the following elements: an evaluation item ID, an evaluation grade ID, a grade description, and a grade score. Here, the evaluation item ID represents an evaluation item corresponding to the defined evaluation grade; the evaluation grade ID is an ID of the evaluation grade; the grade description is a language description displayed to an examiner, for example, severe or medium; the grade score is a grade score corresponding to the evaluation grade. The quality inspection evaluation system may determine corresponding grade scores according to evaluation grades selected by the examiner, so as to avoid an evaluation difference between different examiners.

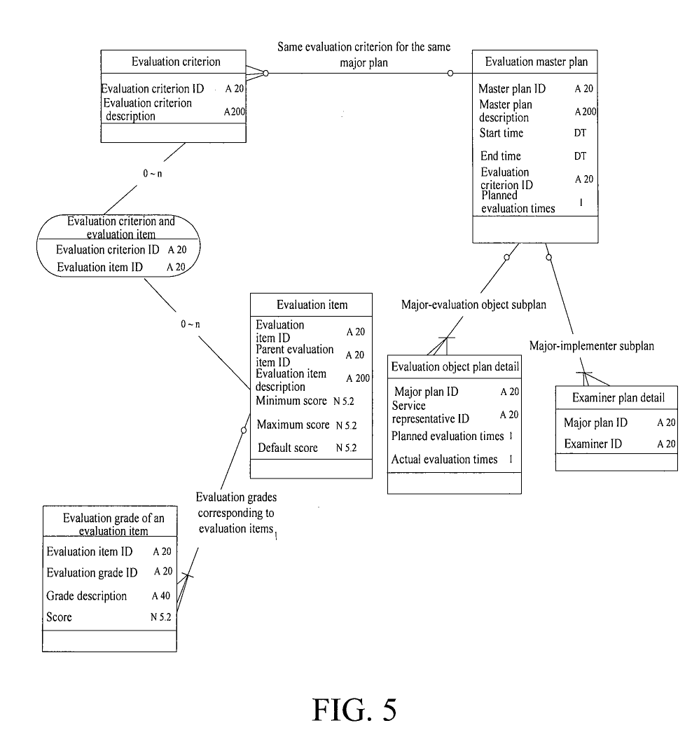

Based on the above setting, a database relation between evaluation criteria, evaluation items, evaluation grades of the evaluation items, evaluation major plans, and plan details is as shown in FIG. 5.

Block 402: Automatic fetching strategies are set.

In this block, an administrator configures an automatic fetching strategy for each of the preset evaluation major plans, and the automatic fetching device in the quality inspection evaluation system receives the configuration of the administrator, and stores the automatic fetching strategies in the memory.

Each of the configured automatic fetching strategies includes a service representative fetching strategy and a service record data fetching strategy. The service representative fetching strategy includes one or more rule conditions that a fetched service representative is required to satisfy, for example, an employee ID range of service representatives, a duration of average online call, history service record time, and a class of the user that has been served. The service record data fetching strategy includes one or more rule conditions that the obtained service record data is required to satisfy, for example, start time and end time of the service record data, a duration of the service record data, a call duration, a user class, a user brand, and a service type.

The set automatic fetching strategy may contain the following elements: a strategy ID and a strategy description. The rule conditions included in the above automatic fetching strategy contains the following elements: a rule ID, a rule description, rule factors, logical operators, and factor values. The logical operations of the rule factors can be used, for example, ‘Between’, ‘=’, ‘>’, ‘<’, ‘>=’, ‘<=’, and ‘!=’. A rule factor must be one of attributes of the evaluation objects, for example, an employee ID of a service representative, or time of service record data.

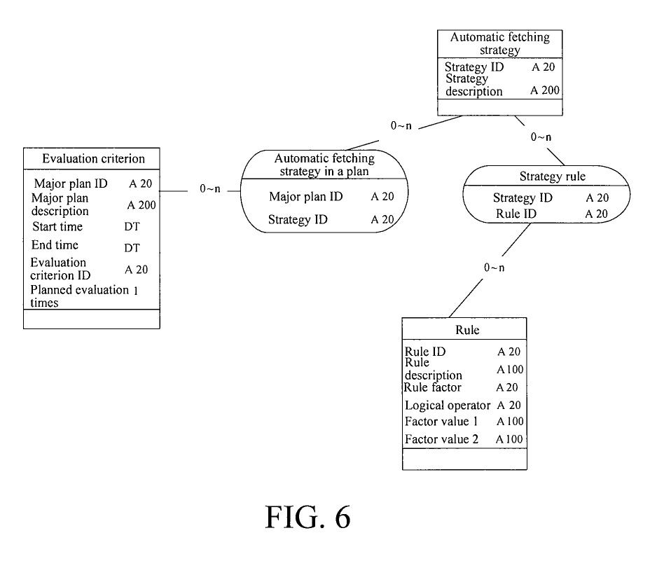

A relationship between evaluation major plans, automatic fetching strategies, and rule conditions included in the automatic fetching strategies is as shown in FIG. 6.

Block 403: An evaluation task of the evaluation process to be performed and candidate service representatives of the evaluation process are determined according to an uncompleted evaluation major plan, and then the evaluation process is started.

In this block, the task distributor in the quality inspection evaluation system determines an evaluation major plan to be performed and candidate service representatives. Here, the candidate service representatives refer to service representatives that are possible to be evaluated in the evaluation process.

The evaluation plans are stored in the memory of the quality inspection evaluation system. As described in Block 401, an evaluation plan includes a major plan and a plan detail, and an evaluation object plan detail contains planned evaluation times and actual evaluation times. A plan detail corresponding to the evaluation major plan may specify that a service representative is to be evaluated for multiples times by setting the planned evaluation times in the evaluation object plan detail. The task distributor in the quality inspection evaluation system may judge whether an evaluation major plan is completed or not according to a relation between planned evaluation times and actual evaluation times in the evaluation object plan detail corresponding to the evaluation major plan. Specifically, it is judged whether a service representative with actual evaluation times fewer than the planned evaluation times exists in an evaluation object plan detail corresponding to an evaluation major plan or not; if the service representative with actual evaluation times fewer than the planned evaluation times exists, it is determined that the evaluation major plan is not completed. If in an evaluation object plan detail corresponding to an evaluation major plan, actual evaluation times of all service representatives have reached planned evaluation times, it indicates that the evaluation major plan is completed.

After an examiner logs in to the quality inspection evaluation system, the task distributor of the quality inspection evaluation system queries based on the above ways, for an evaluation major plan that has not been completed by the examiner according to an examiner ID input by the examiner and the evaluation plans stored in the memory. If the examiner has a plurality of uncompleted evaluation major plans, the uncompleted evaluation major plans of the examiner that are found are displayed as a list, the examiner selects an evaluation major plan to be performed from the list, and the evaluation major plan selected by the examiner is determined as an evaluation major plan to be performed in the evaluation process, thus determining the evaluation task of the evaluation process. If the examiner has only one uncompleted evaluation major plan, this uncompleted evaluation major plan is directly used as the evaluation major plan to be performed in the evaluation process, so as to determine the evaluation task of the evaluation process. Then, in an evaluation object plan detail corresponding to the evaluation major plan that is finally determined to be performed in the evaluation process, service representatives with the actual evaluation times fewer than the planned evaluation times are determined as the candidate service representatives of the evaluation process.

In this block, during the process of determining the evaluation task to be performed in the evaluation process and the candidate service representatives of the evaluation process, the examiner neither needs to perform a manual query, nor to know specific details of the plan, so that the work efficiency is improved, and a comprehensive, accurate, objective, fair, and just evaluation result is ensured.

In the above process, the details of the task distributor (Auto Task Distribute) are as follows.

cAutoTaskDistribute

| | | |
|---|---|---|
| + | GetPlan ( ) | :int |
| + | GetPlanDetail ( ) | :int |

Auto Task Distribute mainly provides a method for obtaining an evaluation major plan (Get Plan) and a method for obtaining a plan detail (Get Plan Detail).

Get Plan is to obtain uncompleted major plan information according to an examiner ID.

Get Plan Detail is to determine a list of candidate service representatives.

Block 404: The quality inspection evaluation system automatically fetches a service representative.

In this block, the automatic fetching device in the quality inspection evaluation system automatically fetches a service representative according to an evaluation object fetching strategy set in Block 402. Here, the mode for automatically fetching the service representative slightly varies with different types of the evaluation task of the evaluation process.

Specifically, according to the evaluation major plan of the evaluation process that is determined in the task distributor, the automatic fetching device in the quality inspection evaluation system extracts a service representative fetching strategy in the evaluation object fetching strategy corresponding to the major plan from the memory, and resolves the rules contained in the strategy. During the resolution, the rules may be resolved by using the logic of the automatic fetching device, or resolved by invoking a third-party rule resolver.

When the evaluation task of the evaluation process is a real-time evaluation, the automatic fetching device of the quality inspection evaluation system extracts an intersection set between the candidate service representatives of the evaluation process that are determined by the task distributor and current online service representatives, determines a subset of service representatives that conforms to the service representative fetching strategy by using the resolved service representative fetching strategy from the intersection set, randomly fetches a service representative from the subset, and provides the service representative to the evaluation executor of the quality inspection evaluation system. Here, a mode for determining the current online service representatives may be as follows: the automatic fetching device obtains employee IDs of the current online service representatives from a connection system. For example, it is assumed that the candidate service representatives of the evaluation process is A1, A2, A3, A4, A5, and A6, and a set of current online service representatives is A1, A2, A3, A5, and A7, so the intersection set between the candidate service representatives and the current online service representatives is A1, A2, A3, and A5; afterwards, a subset that conforms to the service representative fetching strategy is determined in the intersection set, that is, A1, A3, and A5; accordingly, a service representative, for example, A3, is randomly fetched from the three service representatives to serve as the service representative of the evaluation process.

When the evaluation task of the evaluation process is a post evaluation, the automatic fetching device of the quality inspection evaluation system extracts the candidate service representatives of the evaluation process determined by the task distributor, determines a subset of service representatives that conforms to the service representative fetching strategy by using the resolved service representative fetching strategy, and randomly fetches a service representative from the subset. For example, it is assumed that the candidate service representatives of the evaluation process is A1, A2, A3, A4, A5, and A6, and a subset among the service representatives that conforms to the service representative fetching strategy is A1, A2, and A6; accordingly, a service representative, for example, A2, is randomly fetched from the three service representatives to serve as the service representative of the evaluation process.

After the service representative is fetched, Block 405 is performed for the post evaluation, and Block 406 is performed for the real-time evaluation.

Block 405: Various types of interface information of the service record data of the service representative is obtained, and Block 407 is performed.

In the quality inspection evaluation system, the service record data of service representatives is generally stored in various subsystems. When it is to obtain service record data of a service representative, interface information corresponding to the service record data is to be determined, so as to obtain the service record data from a corresponding subsystem by using the interface information.

In this block, the automatic fetching device in the quality inspection evaluation system automatically obtains the interface information of the service record data of the service representative of the evaluation process that is determined in Block 404 according to the evaluation object fetching strategy set in Block 402.

Specifically, according to the evaluation task of the evaluation process determined in the task distributor, the automatic fetching device in the quality inspection evaluation system extracts a service record data fetching strategy in the evaluation object fetching strategy corresponding to the evaluation major plan from the memory, and resolves the rules contained in the strategy. During the resolution, the rules may be resolved by using the logic of the automatic fetching device, or resolved by invoking a third-party rule resolver. A type of the service record data that needs to be obtained can be determined by the above resolution process, and then the interface information of the service record data of the corresponding type can be obtained.

When the evaluation task is a post evaluation, the quality inspection evaluation system randomly obtains interface information corresponding to a history service record of the service representative determined in Block 404 according to the evaluation major plan of the evaluation process, and transports the interface information to the evaluation executor. Here, data of the history service record includes, but is not limited to, a history call record, an SMS/MMS/FAX/EMAIL/CHAT contact record, a screen record content, and service conditions of a service process such as a service request, a service handling log, a work list, or a questionnaire. Thus, the operation of acquiring the interface information of the service record data in this block is completed.

It can be known from Blocks 404 and 405 that, in this embodiment, the automatic fetching device (AutoFetch) of the quality inspection evaluation system mainly provides the following methods.

cAutoFetch

| | | |
|---|---|---|
| + | GetStrategyByPlanID ( ) | :int |
| + | GetStrategyRule ( ) | :int |
| + | AnalyStrategy ( ) | :int |
| + | FetchStaffObject ( ) | :int |
| + | FetchRecordObject ( ) | :int |

Get Strategy By Plan ID is to obtain a corresponding automatic fetching strategy according to an evaluation plan ID.

Get Strategy Rule is to obtain strategy rules according to a strategy ID.

Analyses Strategy is to resolve the strategy rules, and may also invoke a third-party rule resolver to resolve the strategy rules.

Fetch Staff Object is to fetch a service representative of the evaluation process that satisfies a condition according to the strategy rules.

Fetch Record Object is to obtain service record data of the service representative of the evaluation process that satisfies the condition according to the strategy rules.

Block 406: The quality inspection evaluation system provides an ID of the service record data of the service representative of the evaluation process to the evaluation executor.

Block 407: The quality inspection evaluation system requests a connection system for monitoring or playback.

In this block, after obtaining information of the service representative of the evaluation process, the evaluation executor of the quality inspection evaluation system plays back communication data between the service representative and a user for a real-time evaluation or a post evaluation. Specifically, for the real-time evaluation, the evaluation executor sends a monitor request to a connection device in the connection system to request for monitoring the service representative of the evaluation process and playing back current communication data; and for the post evaluation, the evaluation executor sends a playback request to the connection device in the connection system to request for playing back audio of the history service record of the service representative of the evaluation process. It should be understood that, for the post evaluation, the audio of the history service record of the service representative may also be downloaded locally, and played back with an audio adapter.

Block 408: An evaluation interface is constructed according to an evaluation criterion corresponding to an evaluation plan, and is displayed to the examiner.

In this block, the evaluation executor in the quality inspection evaluation system constructs an evaluation interface according to the evaluation criterion corresponding to the evaluation major plan set in Block 401.

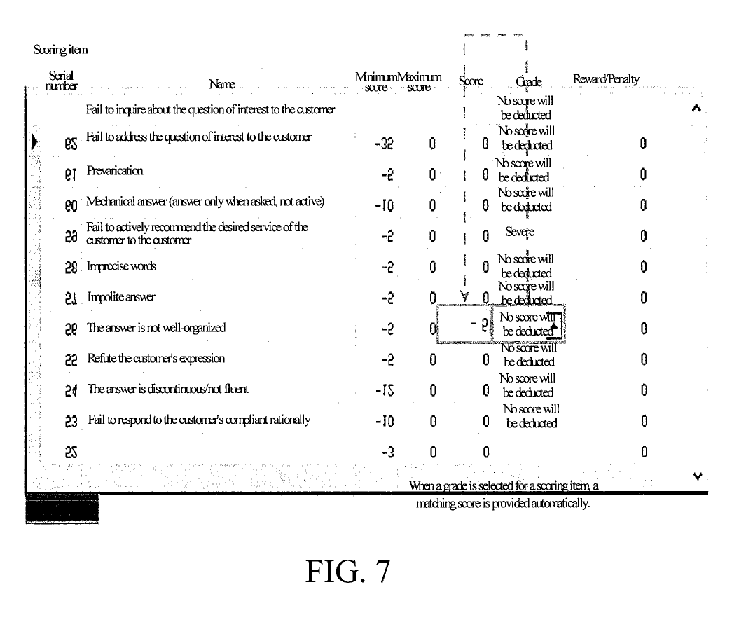

Specifically, according to the evaluation major plan determined by the task distributor, the evaluation executor in the quality inspection evaluation system queries for and extracts an evaluation criterion corresponding to the evaluation major plan as well as evaluation items corresponding to the evaluation criterion from the memory, and constructs the evaluation interface according to the extracted contents. Preferably, an evaluation grade is set for each evaluation item in Block 401. In this block, the evaluation grade may be contained in the evaluation interface, and displayed to the examiner. FIG. 7 is a schematic view of an evaluation interface. Referring to FIG. 7, the evaluation interface contains name, minimum score, maximum score, score, evaluation grade, and other entries for each evaluation item.

In addition, for the post evaluation, the evaluation executor may further display the interface information related to the history service record of the service representative obtained by the automatic fetching device on the evaluation interface, and the examiner selects corresponding data as a basis for evaluating the service representative.

Block 409: The quality inspection evaluation system provides the service record data of the service representative of the evaluation process to the examiner.

In this block, for the real-time evaluation, the evaluation executor of the quality inspection evaluation system requests the connection system for monitoring the service representative determined in Block 404 and provide a picture of the service representative that is displayed on the same screen to the examiner, so as to enable the examiner to obtain current operation data of the service representative in real-time, for example, an SMS/MMS/FAX/EMAIL/CHAT contact record, or a filling condition of a work list, a questionnaire, or a service handling log.

For the post evaluation, according to a selection of the examiner, the evaluation executor of the quality inspection evaluation system obtains and plays back history operation data of the service representative designated by the examiner through a corresponding interface provided by the automatic fetching device to the evaluation executor. Specifically, a history service track is played back by invoking a corresponding interface, and the playback of the history service track includes, but is not limited to, playback of a history call record, playback of an SMS/MMS/FAX/EMAIL/CHAT contact record in a time sequence, screen record playback, and playback and display of a process track of service processes such as a service request, a service handling log, a work list, or a questionnaire.

Through Blocks 407 and 409, the communication data and operation data between the service representative and the user can be obtained respectively, which both belong to the service record data of the service representative. The examiner may obtain any one or both of the data as required, so as to evaluate the service quality of the service representative.

Block 410: The examiner determines a score for each evaluation item according to the obtained service record data.

In this block, preferably, an evaluation grade is determined for each evaluation item, that is, the examiner determines an evaluation grade of each evaluation item according to the obtained service record data of the service representative of the evaluation process and a preset corresponding relation between evaluation grades and scores, and the quality inspection evaluation system receives evaluation grades input by the examiner, and determines a score of each evaluation item according to the corresponding relation between evaluation grades and scores set in Block 401. By using such a scoring mode, the defect that different examiners give different scores for the same problem of the same severity is effectively avoided.

It should be understood that, a mode in the prior art may also be used, that is, an examiner directly gives a score for each evaluation item according to the service record data; however, it is obvious that a score difference caused by different examiners cannot be avoided if this mode is adopted.

Block 411: The scores of the evaluation items are summarized to obtain an evaluation result of the evaluation process, and the result is stored in the memory.

In this block, the scores of the evaluation items may be summarized according to a predefined evaluation result computing method so as to determine the evaluation result of the evaluation process, and the result is stored in the memory. Meanwhile, value of 1 is added to actual evaluation times in the evaluation object plan detail corresponding to the service representative of the evaluation process.

Thus, a quality inspection evaluation process using the method and system of the present invention is completed. The method for evaluating quality inspection and system of the present invention are both illustrated by taking an evaluation according to evaluation plans for example. In fact, an unplanned evaluation may also be performed. Specifically, an evaluation authority of an examiner to service representatives, evaluation criteria, and evaluation items may be preset in the memory of the quality inspection evaluation system, and actual evaluation times of each service representative are stored; when it is to determine candidate service representatives, the task distributor selects service representatives that conform to the evaluation authority from service representatives with actual evaluation times fewer than a preset threshold to serve as candidate service representatives according to an ID of the examiner that performs the evaluation process, and provides the candidate service representatives to the automatic fetching device. Accordingly, a plurality of evaluation object fetching strategies may also be preset in the memory of the quality inspection evaluation system, and displayed to the examiner. The automatic fetching device determines an evaluation object fetching strategy of the evaluation process according to a selection of the examiner, automatically fetches a service representative from the candidate service representatives, and automatically obtains service record data of the fetched service representative according to the evaluation object fetching strategy. A specific operation of fetching the service representative and acquiring the service record data according to the evaluation object fetching strategy is the same as that described in the above embodiment. In addition, when it is to determine an evaluation criterion and evaluation items corresponding to the evaluation criterion, the evaluation criterion and the evaluation items corresponding to the evaluation criterion are determined according to a preset evaluation task template, an evaluation grade is selected for each of the determined evaluation items according to the obtained service record data, a score of each evaluation item is determined according to a preset corresponding relation between evaluation grades and scores, and the quality inspection evaluation system determines the result of the evaluation process according to the scores of the evaluation items.

It can be seen from the above description that, with the method for evaluating quality inspection and system of the present invention, a comprehensive, accurate, objective, fair, and just evaluation result can be ensured. Specifically, by setting the evaluation plans, it is ensured that the evaluated service representatives are evaluated for the same evaluation times; by using the task distributor, evaluation major plans are automatically distributed, thus improving the efficiency; by using the automatic fetching device, a service representative to be evaluated and service record data thereof are automatically and randomly fetched, thus ensuring that the evaluated service representative is evaluated by different examiners at the same probability; and by using the evaluation grades, an evaluation difference between different examiners is avoided.

Those of ordinary skill in the art should understand that all or a part of the blocks in the method according to the embodiments of the present invention can be implemented by a program instructing relevant hardware, and the program may be stored in a computer readable storage medium, such as a read-only memory (ROM), a random access memory (RAM), a magnetic disk, or an optical disk.

The above descriptions are merely preferred embodiments of the present invention, but are not intended to limit the scope of the present invention. Any modification, equivalent replacement, and improvement made without departing from the spirit and principle of the present invention shall fall within the protective scope of the present invention.

What is claimed is:

1. A method for evaluating quality inspection, comprising:
by a quality inspection evaluation system, determining an evaluation task and candidate service representatives of an evaluation process, and automatically fetching a service representative of the evaluation process from the candidate service representatives;
automatically obtaining, by the quality inspection evaluation system, service record data of the fetched service representative according to the evaluation task; and
determining, by the quality inspection evaluation system, a result of the evaluation process according to the obtained service record data.

2. The method according to claim 1, wherein the determining the evaluation task and the candidate service representatives of the evaluation process comprises:
determining the evaluation task of the evaluation process according to an evaluation major plan selected by an examiner from uncompleted evaluation major plans, and determining service representatives with actual evaluation times fewer than planned evaluation times in an evaluation object plan detail corresponding to the selected evaluation major plan as the candidate service representatives of the evaluation process.

3. The method according to claim 2, wherein a mode for determining the uncompleted evaluation major plans comprises:
judging whether a service representative with actual evaluation times fewer than planned evaluation times exists or not according to the evaluation object plan detail corresponding to each of the evaluation major plans; and determining the corresponding evaluation major plan as the uncompleted evaluation master plan, if the service representative with the actual evaluation times fewer than the planned evaluation times exists.

4. The method according to claim 2, further comprising:
determining, by the quality inspection evaluation system, an evaluation object fetching strategy corresponding to the evaluation major plans as an evaluation object fetching strategy of the evaluation process, wherein the evaluation object fetching strategy corresponding to the evaluation major plans is preset in the quality inspection evaluation system;
wherein automatically fetching a service representative of the evaluation process comprises automatically fetching a service representative of the evaluation process according to the evaluation object fetching strategy; and
wherein automatically obtaining service record data of the fetched service representative comprises automatically obtaining service record data of the fetched service representative according to the evaluation object fetching strategy.

5. The method according to claim 1, wherein the determining the candidate service representatives of the evaluation process comprises:
selecting service representatives that conform to a preset evaluation authority of an examiner to the service representatives from the service representatives with the actual evaluation times fewer than a preset threshold as the candidate service representatives according to an identity of the examiner.

6. The method according to claim 1, further comprising:
determining, by the quality inspection evaluation system, an evaluation object fetching strategy of the evaluation process according to a selection of the examiner from a plurality of preset evaluation object fetching strategies;
wherein automatically fetching a service representative of the evaluation process comprises automatically fetching a service representative of the evaluation process according to the evaluation object fetching strategy; and
wherein automatically obtaining service record data of the fetched service representative comprises automatically obtaining service record data of the fetched service representative according to the evaluation object fetching strategy.

7. The method according to claim 4, wherein the evaluation object fetching strategy comprises a service representative fetching strategy; and
wherein automatically fetching a service representative of the evaluation process according to the evaluation object fetching strategy comprises one of the following:
determining, by the quality inspection evaluation system, a subset of service representatives that conform to the service representative fetching strategy from an intersection set between the candidate service representatives of the evaluation process and current online service representatives and randomly fetching the service representative from the subset when the evaluation task is a real-time evaluation; and
determining, by the quality inspection evaluation system, a subset of service representatives that conform to the service representative fetching strategy from a set of candidate service representatives of an evaluation plan, and randomly fetching the service representative from the subset when the evaluation task is a post evaluation.

8. The method according to claim 7, wherein the service representative fetching strategy comprises rule condition that the service representatives are required to satisfy, and the rule conditions comprise at least one of an employee identity range of the service representatives, a duration of average online call, history service record time, and class of the user that has been served.

9. The method according to claim 4, wherein the evaluation object fetching strategy comprises a service record data fetching strategy; and
wherein automatically obtaining service record data of the fetched service representative according to the evaluation object fetching strategy comprises one of the following:
obtaining one of current communication data between the service representative and a user and current operation data of the service representative through a monitoring system when the evaluation task is a real-time evaluation; and
obtaining one of history communication data between the service representative that conforms to the service record data fetching strategy and a user and history operation data of the service representative that conforms to the service record data fetching strategy, when the evaluation task is post evaluation.

10. The method according to claim 9, wherein the service record data fetching strategy comprises rule condition that the service record data is required to satisfy, and the rule condition comprises at least one of start time and end time of the service record data and a duration of the service record data.

11. The method according to claim 2, wherein the determining the result of the evaluation process according to the obtained service record data comprises:
determining a set evaluation criterion and evaluation items corresponding to the evaluation criterion according to the evaluation major plan;
selecting an evaluation grade for each of the determined evaluation items according to the obtained service record data;
determining a evaluation score of each of the evaluation items according to a preset corresponding relation between evaluation grades and evaluation scores; and
determining the result of the evaluation process according to the evaluation score of each of the evaluation items.

12. The method according to claim 2, further comprising:
adding value of 1 to the actual evaluation times of the service representative of the evaluation process and storing the result of the evaluation process.

13. The method according to claim 2, wherein the determining the result of the evaluation process according to the obtained service record data comprises:
determining an evaluation criterion and evaluation items corresponding to the evaluation criterion according to a preset evaluation task template;
selecting an evaluation grade for each of the determined evaluation items according to the obtained service record data;
determining a evaluation score of each of the evaluation items according to a preset corresponding relation between evaluation grades and evaluation scores; and
determining, by a quality inspection evaluation system, the result of the evaluation process according to the scores of the evaluation items.

14. The method according to claim 1, wherein the automatically fetching the service representative from the candidate service representatives comprises:
randomly fetching the service representative from the candidate service representatives.

15. A quality inspection evaluation system, comprising a task distributor, an automatic fetching device and an evaluation executor, wherein
the task distributor is adapted to determine an evaluation task of an evaluation process;
the automatic fetching device is adapted to automatically fetch a service representative of the evaluation process and automatically obtain service record data of the fetched service representative according to the evaluation task determined by the task distributor, and to provide the service representative and the service record data to the evaluation executor; and
the evaluation executor is adapted to play back the service record data obtained by the automatic fetching device, and determine a result of the evaluation process according to the service record data.

16. The system according to claim 15, further comprising: a memory, adapted to store preset evaluation major plans; wherein
the task distributor is adapted to obtain current uncompleted evaluation major plans from the memory, determine an evaluation major plan of the evaluation process according to a selection of an examiner, and determine the evaluation task of the evaluation process according to the evaluation major plan

17. The system according to claim 16, wherein the memory further stores an automatic fetching strategy corresponding to each evaluation plan; wherein the automatic fetching device is adapted to automatically fetch a service representative of the evaluation process and automatically obtain service record data of the fetched service representative according to the automatic fetching strategy.

18. The system according to claim 16, wherein the memory further stores an evaluation criteria and evaluation items; wherein the evaluation executor is adapted to construct an evaluation interface according to the evaluation criteria and the evaluation items in the memory, and play back the service record data corresponding to the service representative according to a selection of the examiner.

19. A computer readable medium, comprising computer program codes stored thereon, executable by one or more digital processor for evaluating quality inspection, wherein the computer program codes comprise:
instructions for determining an evaluation task and candidate service representatives of an evaluation process, and automatically fetching a service representative of the evaluation process from the candidate service representatives;
instructions for automatically obtaining service record data of the fetched service representative according to the evaluation task; and
instructions for determining a result of the evaluation process according to the obtained service record data.
